(19) United States
(12) Patent Application Publication
(10) Pub. No.: US 2006/0126432 A1
(43) Pub. Date: Jun. 15, 2006

(54) Marine seismic streamer and method for manufacture thereof

(76) Inventor: Jeroen Hoogeveen, Bekkestua (NO)

Correspondence Address: E. Eugene Thigpen;Petroleum Geo-Services, Inc., P.O. Box 42805, Houston, TX, 77242-2805, US

(21) Appl. No.: 11/009,804

(22) Filed: Dec. 10, 2004

(51) Int. Cl. G01V 1/38

(52) U.S. Cl. 367/20

(57) ABSTRACT

A seismic streamer includes a jacket covering an exterior of the streamer. At least one strength member extends along the length of the jacket. The strength member is disposed inside the jacket. Seismic sensors are disposed at spaced apart locations along the interior of the jacket. A flexible, acoustically transparent material fills the space inside the jacket. The material is introduced into the inside of the jacket in liquid form and undergoes a state change thereafter. The strength member, prior to and during the state change, is maintained in substantially a same position with respect to the jacket as would occur during ordinary operation of the streamer. The maintaining position is performed at least at a location along the jacket where a device is to be coupled externally to the jacket.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF INVENTION

1. Field of the Invention

The invention relates generally to the field of marine seismic data acquisition equipment. More specifically, the invention relates to structures for a marine seismic streamer, and methods for making such streamers.

2. Background Art

Marine seismic surveying is typically performed using “streamers” towed near the surface of a body of water. A streamer is in the most general sense a cable towed by a seismic vessel having a plurality of seismic sensors disposed thereon at spaced apart locations. The sensors are typically hydrophones, but can also be any type of sensor that is responsive to the pressure in the water, or in changes therein with respect to time. The sensors may also be any type of particle motion sensor or acceleration sensor known in the art. Irrespective of the type of such sensors, the sensors generate an electrical or optical signal that is related to the parameter being measured by the sensors. The electrical or optical signals are conducted along electrical conductors or optical fibers carried by the streamer to a recording system. The recording system is typically disposed on the seismic vessel, but may be disposed elsewhere.

In a typical marine seismic survey, a seismic energy source is actuated at selected times, and a record, with respect to time, of the signals detected by the one or more sensors is made in the recording system. The recorded signals are later used for interpretation to infer structure of, fluid content of, and composition of rock formations in the Earth's subsurface.

A typical marine seismic streamer can be up to several kilometers in length, and can include hundreds of individual seismic sensors. Because of the weight of all of the materials used in a typical marine seismic sensor, because of the friction (drag) caused by the streamer as it is moved through the water, and because of the need to protect the sensors, electrical and/or optical conductors and associated equipment from water intrusion, a typical seismic streamer includes certain features. First, the streamer includes one or more strength members to transmit axial force along the length of the streamer. The strength member is operatively coupled to the seismic vessel and thus bears all the loading caused by drag (friction) of the streamer in the water. The streamer also includes, as previously explained, electrical and/or optical conductors to carry electrical power and/or signals to the various sensors and (in certain streamers) signal conditioning equipment disposed in the streamer and to carry signals from the various sensors to a recording station. The streamer typically includes an exterior jacket that surrounds the other components in the streamer. The jacket is typically made from a strong, flexible plastic such as polyurethane, such that water is excluded from the interior thereof, and seismic energy can pass essentially unimpeded through the jacket to the sensors. A typical streamer also includes buoyancy devices at spaced apart locations therealong, so that the streamer so that the cable is substantially neutrally buoyant in the water. The interior of the jacket is typically filed with oil or similar electrically insulating fluid that is substantially transparent to seismic energy.

Another device that is typically affixed to a streamer at spaced apart locations therealong is known as a “compass bird.” A compass bird includes a directional sensor, typically a magnetometer, to determine the orientation of the streamer at the position of the compass bird. The compass bird may include an electromagnetic transducer to communicate its measurements through the streamer jacket to a detector inside the jacket. Direction measurements are used to infer the position of the streamer along its length, because currents in the body of water can cause the streamer to move transversely with respect to the direction of motion of the seismic vessel.

A seismic streamer including the various components described above is typically made by inserting the various components inside the jacket, and filling the interior space within the jacket with oil or other electrically insulating material. During manufacture, axial stress may be applied to the strength member, and during handling and storage, essentially no axial stress is applied. As a result, the various components within the jacket may move laterally and/or axially with respect to the jacket. Thus, the geometry of the typical streamer may change between handling, storage, deployment and actual operation, where substantial axial force is applied to the strength member. Compass bird orientation with respect to the streamer jacket and internal components is particularly susceptible to error due to changes in streamer component geometry.

There is a need for a marine seismic streamer that has precisely controlled geometry during manufacture, and which geometry substantially does not change between manufacture, handling, storage and use.

### SUMMARY OF INVENTION

One aspect of the invention is a seismic streamer, including a jacket covering an exterior of the streamer. At least one strength member extends along the length of the jacket. The strength member is disposed inside the jacket. Seismic sensors are disposed at spaced apart locations along the interior of the jacket. A flexible, acoustically transparent material fills the space inside the jacket. The material is introduced into the inside of the jacket in liquid form and undergoes a state change thereafter. The strength member is maintained at least near a position along the jacket to which a device is to be attached externally, during the state change in substantially axial alignment with the jacket.

Another aspect of the invention is a method for making a seismic streamer. A method according to this aspect includes inserting at least one strength member and seismic sensors into a jacket. The jacket is then filled with a liquid having a composition adapted to undergo a change in state from liquid to substantially solid after the filling. The strength member is held, during the state change, in substantially axial alignment with the jacket. The holding is performed at least at a location along the jacket at which a device is to be externally affixed. In one embodiment, a selected tension is applied to the at least one strength member to effect the holding. In one embodiment, the tension is an amount selected to maintain the strength member and the sensors in essentially the desired position of the strength member with respect to the jacket when the streamer is towed by a seismic vessel in a body of water.

Other aspects and advantages of the invention will be apparent from the following description and the appended claims.

### BRIEF DESCRIPTION OF DRAWINGS

FIG. 1 shows typical marine seismic data acquisition using a streamer according to one embodiment of the invention.

FIG. 2 shows a cut away view of one embodiment of a streamer segment according to the invention.

### DETAILED DESCRIPTION

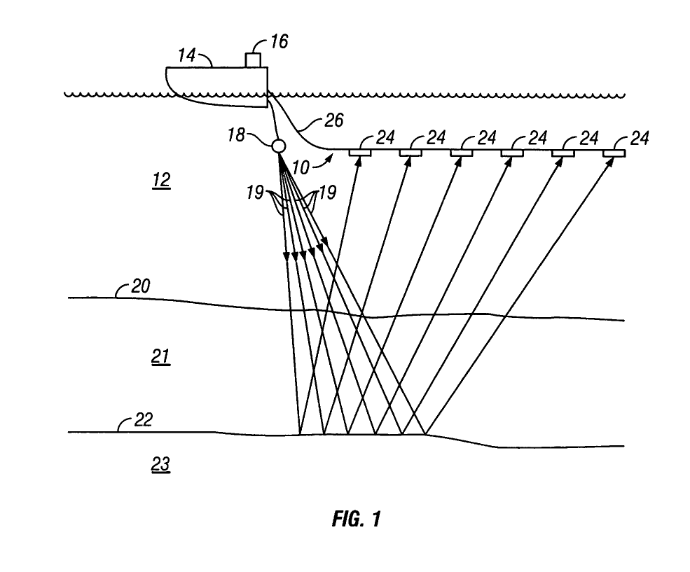

An example marine seismic data acquisition system as it is typically used is shown in FIG. 1. A seismic vessel 14 moves along the surface of a body of water 12 such as a lake or the ocean. The marine seismic survey is intended to detect and record seismic signals related to structure and composition of various subsurface Earth formations 21, 23 below the water bottom 20. The seismic vessel 14 includes source actuation, data recording and navigation equipment, shown generally at 16, referred to for convenience as a “recording system.” The seismic vessel 14, or a different vessel (not shown), can tow one or more seismic energy sources 18, or arrays of such source(s) in the water 12. The system includes at least one seismic streamer 10, which includes a strength member 26 operatively coupled to the seismic vessel 14, and a plurality of sensors 24 or arrays of such sensors, disposed at spaced apart locations along the streamer 10. During operation, equipment (not shown separately) in the recording system 16 causes the source 18 to actuate at selected times. When actuated, the source 18 produces seismic energy 19 that emanates generally outwardly from the source 18. The energy 19 travels downwardly, through the water 12, and passes, at least in part, through the water bottom 20 into the formations 21, 23 below. Seismic energy 19 is at least partially reflected from one or more acoustic impedance boundaries 22 below the water bottom 20, and travels upwardly whereupon it may be detected by the sensors 24. Structure of the formations 21, 23 can be inferred by travel time of the energy 19 and by characteristics of the detected energy such as its amplitude and phase.

An important aspect of inferring the structure of the formations 21, 23 is precise knowledge of the geographic position of the sensors 24 during the survey, so that the geographic position of the boundaries 22 may be correctly inferred and so that the geographic position of various compositions of the formations 21, 23 may be estimated accurately.

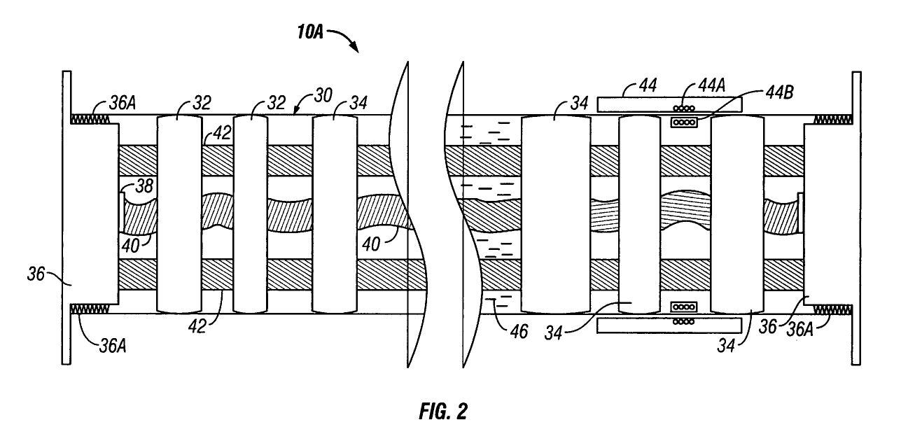

Having explained the general method of operation of a marine seismic streamer, an example embodiment of a streamer according to the invention will be explained with reference to FIG. 2. FIG. 2 is a cut away view of a portion (segment) 10A of a marine seismic streamer (10 in FIG. 1). A streamer as shown in FIG. 1 may extend behind the seismic vessel (14 in FIG. 1) for several kilometers, and is typically made from a plurality of streamer segments as shown in FIG. 2 connected end to end behind the vessel (14 in FIG. 1).

The streamer segment 10A in the present embodiment may be about 75 meters overall length. A streamer such as shown at 10 in FIG. 1 may be formed by connecting a selected number of such segments 10A end to end. The segment 10A includes a jacket 30, which in the present embodiment is made from 3.5 mm thick transparent polyurethane, having a nominal external diameter of about 62 millimeters. In some embodiments, the jacket 30 may be externally banded in selected places with an alloy number 304 stainless steel, copper flashed band (not shown).

In each segment 10A, each axial end of the jacket 30 may be terminated by a coupling/termination plate 36. The termination plate 36 may include elements 36A on a surface inserted into the end of the jacket 30 to seal against the inner surface of the jacket 30, and to grip the termination plate 36 to the jacket 30 when clamped externally (not shown). In the present embodiment, two strength members 42 are coupled to the interior of each termination plate 36 and extend the length of the segment 10A. In a particular implementation of the invention, the strength members 42 may be made from a fiber rope, using a fiber sold under the mark VECTRAN, which is a registered trademark of Hoechst Celanese Corp., New York, N.Y. The strength members 42 transmit axial force along the length of the segment 10A. When one segment 10A is coupled end to end to another segment (not shown in FIG. 2), mating termination plates 36 are coupled together using any suitable connector, so that the axial force is transmitted through the termination plates 36 from the strength members 42 in one segment 10A to the strength member in the adjoining segment.

The segment 10A includes buoyancy spacers 32 disposed in the jacket 30 at spaced apart locations along its length. The buoyancy spacers 32 may be made from foamed polypropylene. The buoyancy spacers 32 have a density selected to provide the segment 10A with approximately the same overall density as water (12 in FIG. 1), so that the streamer (10 in FIG. 1) will be substantially neutrally buoyant in the water. As a practical matter, the buoyancy spacers 32 provide the segment 10A with an overall density very slightly less than that of fresh water. Appropriate overall density may then be adjusted in actual use by adding selected amounts of dense ballast (not shown) to the exterior of the jacket, thus providing adjustment in the buoyancy for changes in water temperature and salinity.

The segment 10A includes a generally centrally located conductor cable 40 which includes a plurality of insulated electrical conductors (not shown separately), and may include one or more optical fibers (not shown). The cable conducts electrical and/or optical signals from the sensors (which will be further explained below) to the recording system (16 in FIG. 1). The cable may also carry electrical power to various signal processing circuits (not shown separately) disposed in one or more segments 10A or disposed elsewhere along the streamer (10 in FIG. 1). The length of conductor cable 40 within a cable segment 10A is generally longer than the axial length of the segment 10A under the largest expected axial stress, so that the electrical conductors and optical fibers will not experience any substantial axial stress when cable 10 is towed through the water by a vessel. The conductors and optical fibers may be terminated in a connector 38 disposed in each termination plate 36 so that when the segments 10A are connected end to end, corresponding electrical and/or optical connections may be made between the electrical conductors and optical fibers in the conductor cable 40 in adjoining segments 10A.

Sensors, which in the present embodiment may be hydrophones, can be disposed in selected ones of the buoyancy spacers, shown in FIG. 2 generally at 34. The hydrophones in the present embodiment can be or a type known to those of ordinary skill in the art, including but not limited to those sold under model number T-2BX by Teledyne Geophysical Instruments, Houston, Tex. In the present embodiment, each segment 10A may include 96 such hydrophones, disposed in arrays of sixteen individual hydrophones connected in electrical series. In a particular implementation of the invention, there are thus six such arrays, spaced apart from each other at about 12.5 meters. The spacing between individual hydrophones in each array should be selected so that the axial span of the array is at most equal to about one half the wavelength of the highest frequency seismic energy intended to be detected by the streamer (10 in FIG. 1). It should be clearly understood that the types of sensors used, the electrical and/or optical connections used, the number of such sensors, and the spacing between such sensors are only used to illustrate one particular embodiment of the invention, and are not intended to limit the scope of this invention. In other embodiments, the sensors may be particle motion sensors such as geophones or accelerometers. A marine seismic streamer having particle motion sensors is described in U.S. patent application Ser. No. 10/233,266, filed on Aug. 30, 2002, entitled, “Apparatus and Method for Multicomponent Marine Geophysical Data Gathering”, assigned to an affiliated company of the assignee of the present invention and incorporated herein by reference.

At selected positions along the streamer (10 in FIG. 1) a compass bird 44 may be affixed to the outer surface of the jacket 30. The compass bird 44 includes a directional sensor (not shown separately) for determining the geographic orientation of the segment 10A at the location of the compass bird 44. The compass bird 44 may include an electromagnetic signal transducer 44A for communicating signals to a corresponding transducer 44B inside the jacket 30 for communication along the conductor cable 40 to the recording system (16 in FIG. 1). Measurements of direction are used, as known in the art, to infer the position of the various sensors 34 in the segment 10A, and thus along the entire length of the streamer (10 in FIG. 1). Typically, a compass bird will be affixed to the streamer (10 in FIG. 1) about every 300 meters (every four segments 10A). One type of compass bird is described in U.S. Pat. No. 4,481,611 issued to Burrage and incorporated herein by reference.

In the present embodiment, the interior space of the jacket 30 may be filled with a material 46 such as a gel, which may be a curable, synthetic urethane-based polymer. The gel 46 serves to exclude fluid (water) from the interior of the jacket 30, to electrically insulate the various components inside the jacket 30, and to transmit seismic energy freely through the jacket 30 to the sensors 34. The gel 46 in its uncured state is essentially in liquid form. Upon cure, the gel 46 no longer flows as a liquid, but instead becomes substantially solid. However, the gel upon cure retains some flexibility to bending stress, some elasticity, and freely transmits seismic energy to the sensors 34. For purposes of defining the scope of the invention, it should be understood that the gel used in the present embodiment only is one example of a substance which would perform according to the invention. Chemical and/or evaporative curing of a urethane compound is a convenient method for forming a streamer segment according to the invention, however other methods could be used with other materials. For example, heating a selected substance, such as a thermoplastic, above its melting point, and introducing the melted plastic into the interior of the jacket 30, and subsequent cooling, may also be used in a streamer according to the invention. It is preferable that the material used has similar acoustic properties, density and electrical properties as the disclosed BVF-25 urethane so that the streamer will have similar mechanical and acoustic response characteristics to the disclosed streamer. All that is required for the invention to work is that the material undergo a state change from liquid at the time of filling the interior of the jacket to substantially solid thereafter.

In making a streamer according to the invention, first, the components described above including the sensors 34, buoyancy spacers 32, strength members 42 and conductor cable 40 are inserted into the jacket 30. In the present embodiment, the strength members 42 are then stretched to approximately the same degree as would be the case when the streamer is in use towed by the seismic vessel (10 in FIG. 1). By applying the appropriate amount of axial tension to the strength members 42, the spacers 32 and the strength members 42 may be maintained in essentially the same geometry with respect to the jacket 30 that they will assume during operation of the streamer as towed by the seismic vessel. Then, the uncured urethane compound (gel 46) is inserted into the interior of the jacket 30 to fill the space therein. During the time needed for the urethane compound to cure, which may be on the order of two weeks for the present embodiment, the axial tension is maintained on the strength members 42. When the urethane compound is cured, the streamer may be made ready for storage and transportation, such as on a reel (not shown). For the segment embodiment shown in FIG. 2, during assembly of the segment 10A, the termination plates 36 are coupled to the strength member 42, and inserted into the jacket 30. Tension may be applied to the strength members 42 during cure by way of the termination plates 36, thus making a completed segment 10A. Made according to this embodiment, the streamer will maintain essentially the same geometry of the various internal components, including the spacers 32, the sensors 34 and the strength members 42 irrespective of the amount the tension applied to the strength member 42.

In other embodiments, the stretching of the strength members may be made only at the position along the jacket 30 at which the compass bird 44 is to be affixed to the exterior of the jacket.

It should be understood that stretching the strength members is only one convenient way to cause the strength members to remain in their ordinary operating position during cure of the gel 46. For purposes of defining the scope of the invention, it is only necessary to maintain the strength members 42 in their desired position during operation of the streamer, during cure of the gel 46.

Having a curable gel or similar filling the jacket 30, rather than liquid as in prior art streamers, can also reduce the possibility of streamer failure in the event of breach of the jacket 30. In the event of such breach, the substantially solid nature of the cured gel 46 will provide some mechanism to continue to exclude water from the active components of the streamer, including the sensors 34 and the cable conductor 40, similar to the action of a potting compound.

Streamers and streamer segments made according to the various aspects of the invention may have improved control over relative geometry of the internal components as compared with prior art streamers, and may provide more accurate placement of navigational devices thereon for increased accuracy in seismic surveying.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A seismic streamer, comprising:
a jacket covering an exterior of the streamer;
at least one strength member extending along the length of the jacket, the strength member disposed inside the jacket;
seismic sensors disposed at spaced apart locations along the interior of the jacket; and
a flexible, acoustically transparent material filling space inside the jacket, the material introduced into the inside of the jacket in liquid form and undergoing state change thereafter to substantially solid, and wherein the strength member is retained during the state change, at least at a position along the jacket at which a device is to be externally affixed, in substantially axial alignment with the jacket.

2. The streamer of claim 1 wherein the jacket comprises polyurethane.

3. The streamer of claim 1 wherein the at least one strength member comprises fiber rope.

4. The streamer of claim 3 further comprising two strength members.

5. The streamer of claim 1 further comprising buoyancy spacers disposed long the strength member and inside the jacket at spaced apart locations, the spacers having a density selected to provide the streamer with a selected overall density.

6. The streamer of claim 5 wherein the spacers comprise foamed polyurethane.

7. The streamer of claim 1 further comprising a cable disposed inside the jacket, the cable having at least one of electrical conductors and optical fibers, the cable adapted to carry signals from the seismic sensors to a recording system.

8. The streamer of claim 1 wherein the device to be affixed externally to the jacket comprises a navigation device affixed to an exterior of the streamer at a selected location.

9. The streamer of claim 1 wherein the sensors comprise hydrophones.

10. The streamer of claim 1 further comprising a termination plate coupled to each axial end of the jacket, the termination plates each coupled to the strength member at an axial end thereof, the termination plates adapted to coupled to a corresponding termination plate in another segment of the streamer so as to transmit axial force therethrough.

11. A method for making a seismic streamer, comprising:
inserting at least one strength member and seismic sensors into a jacket;
filling the jacket with a liquid, the liquid having a composition adapted to undergo a change in state from liquid to substantially solid after the filling;
placing the at least one strength member in a position with respect to the jacket that is the desired position of the strength member with respect to the jacket when the streamer is towed by a seismic vessel in a body of water, the placing performed at least at a location along the jacket to which a device is to be affixed externally; and
holding the at least one strength member in the position during the state change in state.

12. The method of claim 11 wherein the location is used for a navigation device.

13. The method of claim 11 wherein the placing comprises applying tension to the at least one strength member.
